(19) United States
(12) Patent Application Publication
(10) Pub. No.: US 2003/0105713 A1
(43) Pub. Date: Jun. 5, 2003

(54) Special purpose entity for holders of financial instruments

(76) Inventors: Joshua D. Greenwald, St. Louis Park, MN (US); William J. Putney, Minneapolis, MN (US)

Correspondence Address: Damon L. Boyd, Snell & Wilmer L.L.P., One Arizona Center, 400 East Van Buren, Phoenix, AZ, 85004-2202, US

(21) Appl. No.: 10/308,692

(22) Filed: Dec. 3, 2002

Related U.S. Application Data
(60) Provisional application No. 60/338,495, filed on Dec. 3, 2001.

(51) Int. Cl. G06F 17/60

(52) U.S. Cl. 705/40

(57) ABSTRACT

The present invention provides systems and methods for carrying out financial transactions which protect assets and provide various other advantages comprising a financial institution which issues a payment obligation, a special purpose entity, which acquires a residual obligation to honor the payment obligation as well as funds from the financial institution to honor the obligation. In accordance with various aspects of the present invention, the special purpose entity invests the acquired funds prior to honoring the payment obligation.

### CROSS REFERENCES TO RELATED APPLICATIONS

This application claims the benefit of the filing date of U.S. Provisional Patent Application Serial No. 60/338,495, filed Dec. 3, 2001.

### FIELD OF INVENTION

The present invention relates generally to methods and systems for performing financial services, and, more particularly, to methods and systems for performing financial transactions relating to presenting and paying a financial instrument using an entity separate from the entity issuing the financial instrument.

### BACKGROUND OF THE INVENTION

Many financial instruments issued by a bank or other financial institution are regulated and/or licensed by various laws. For example, cashier or teller checks are typically regulated under the banking laws of the various states. Such “regulated payment obligations” are often sold (along with the funds specified in the instrument) to entities who process payment of the instrument when it is eventually presented for payment. Because such instruments are backed by the assets and/or creditworthiness of the financial institution which issued the instrument, the purchasing entity must also back the instrument with its own financial standing.

In this regard, various financial institutions, such as banks, often have concerns as to the stability of the entity honoring the check. For example, it is desirable for the entity to be protected from bankruptcy. Likewise, in fact, some states require the entity backing the security to maintain a minimum of a 100% reserve in assets of the total value of the checks held and as such, with some exceptions, must have both legal and equitable title to the assets backing the checks.

Accordingly, novel business entities, systems, methods and relationships between those entities are desirable to protect various assets and provide other advantages over the prior art.

### SUMMARY OF THE INVENTION

The present invention provides systems and methods for carrying out financial transactions which secure assets and ensure checks and other financial obligations are honored, as well as provide various other advantages. For example, in an exemplary embodiment of the present invention, a system for carrying out a financial transaction comprises a financial institution which issues a payment obligation and a special purpose entity which acquires: (i) a residual obligation to honor the payment obligation and (ii) funds from the financial institution to honor the obligation. In accordance with various aspects of the present invention, the special purpose entity is provided with the ability to invest the acquired funds prior to honoring the payment obligation.

### BRIEF DESCRIPTION OF THE DRAWINGS

Additional aspects of the present invention will become evident upon reviewing the non limiting embodiments described in the following specification and claims taken in conjunction with the accompanying drawing figure, wherein like numerals designate like elements, and:

FIG. 1 is a block diagram of an exemplary embodiment of a special purpose entity configuration in accordance with the present invention;

FIG. 2 is a block diagram of another exemplary embodiment of a special purpose entity configuration in accordance with the present invention;

FIG. 3 is a block diagram of another exemplary embodiment of a special purpose entity configuration in accordance with the present invention; and

FIG. 4 is a block diagram of still another exemplary embodiment of a special purpose entity configuration in accordance with the present invention.

### DETAILED DESCRIPTION

The following descriptions are exemplary embodiments only, and are not intended to limit the scope, applicability, or configuration of the invention in any way. Rather, the following description provides a convenient illustration for implementing various embodiments of the invention. Various changes may be made in the function and arrangement of elements described in the preferred embodiments without departing from the spirit and scope of the invention as set forth in the appended claims. That is, in this regard, the present invention may be described herein in terms of functional block components and various processing steps. It should be appreciated that such functional blocks may be realized by any number of hardware, firmware, and/or software components configured to perform the specified functions. For example, the present invention may employ various integrated circuit components, e.g., memory elements, digital and/or analog signal processing elements, look-up tables, and the like, which may carry out a variety of functions under the control of one or more microprocessors or other control devices. Such general techniques and components that are known to those skilled in the art are not described in detail herein.

That being said, the present invention provides systems and methods for performing various financial transactions in a manner which gives the organizations involved in the transaction increased security. For example, in accordance with an exemplary embodiment of the present invention, a financial institution such as a bank 100 issues a regulated payment obligation 102, such as a check 102 backed by that financial institution 100. A payment processor 104 and a legally separate entity 106 from the payment processor 104 are provided. In accordance with various aspects of the present invention, separate entity 106 is a trust. For purposes herein, separate entity 106 is referred to as a “special purpose entity” or “SPE”. However, in accordance with various alternative embodiments, SPE 106 may comprise various other legal entities which are suitably capable of performing various functions described herein.

SPE 106 acquires from 100 financial institution funds sufficient to honor regulated payment obligation 102 and a contractual obligation to honor regulated payment obligation 102. Payment processor 104 acquires from financial institution 100 a residual obligation to honor regulated payment obligation 102 if entity 106 does not or cannot pay the obligation.

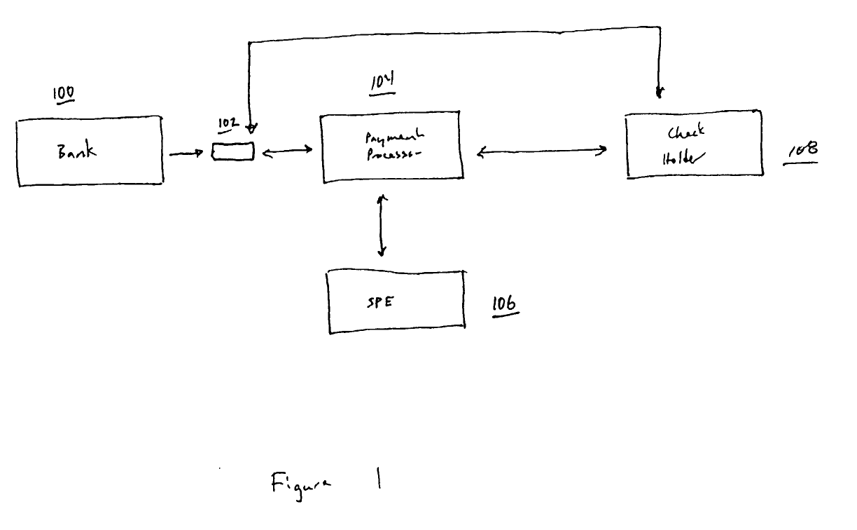

As mentioned above, and with reference to FIG. 1, in the presently described embodiment and in accordance with various aspects of the present invention, financial institution 100 may be a bank, regulated payment obligation 102 is a check and SPE 106, which honors check 102, is a special purpose entity trust. In accordance with various additional aspects of the present invention, the funds sufficient to honor check 102 and likewise cover any transaction costs created by payment processor 104 acquiring funds as well as the legally obligated amount of check 102.

Thus, special purpose entity 106 receives funds directly from bank 100 as a payment of receivables representing the legal obligation to honor the presented check 102. Additionally, as will be described further herein, special purpose entity 106 is able to invest the funds pending payment of check 102.

That being said, with continuing reference to FIG. 1, an exemplary embodiment of systems in accordance with the present invention as illustrated. FIG. 1 illustrates the interaction of bank 100, payment processor 104, SPE 106 and a check holder 108 through various computer networks and software operations. Though not described in detail herein, it should be appreciated that any number and type of network, cabling, telephone lines and computers, and various banking technology, now known or as yet unknown, may be used in accordance with the present invention.

Typically, payment processor 104 provides check services to bank 100, bank 100 issues checks 102 and remits the amounts of checks 102 to payment processor 104 on the business day following issuance of check 102. Payment processor 104 pays check 102 when it is presented through a clearing bank. In the interim, between issuance of check 102 and payments on check 102, payment processor 104 is permitted to invest the funds transferred from bank 100 to payment processor 104 in certain permissible investments. This amount or “float” can then accrue interest. Similarly, in accordance with various aspects of the present invention, in lieu of bank 100 transferring remittances to payment processor 104, bank 100 may present remittances to SPE 106 for presentation.

Preferably, in accordance with various embodiments of the present invention, SPE 106 is suitably contractually prohibited from making a voluntary bankruptcy filing without bank's 100 consent, while being permitted to invest the remittances it receives from bank 100. Additionally, optionally, SPE 106 can be set up in such a way that it is a distinct entity from any other legal entities making SPE 106 a legally separate, bankruptcy remote entity.

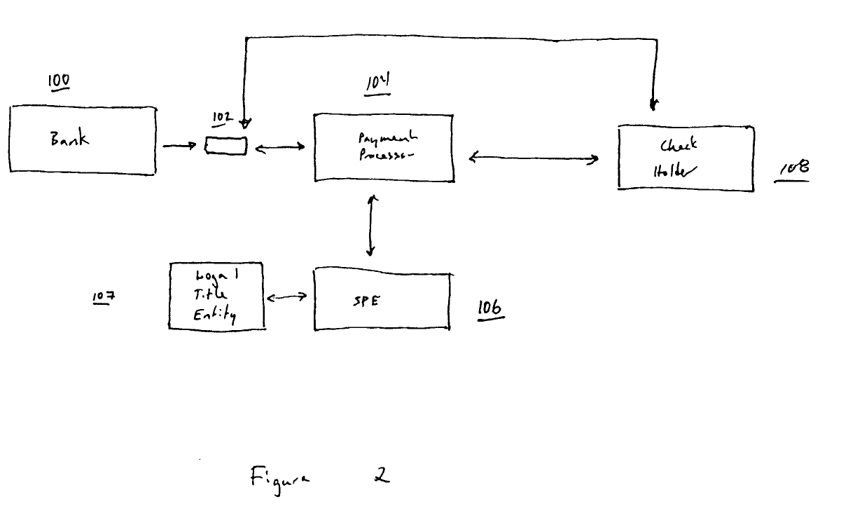

In accordance with another aspect of the present invention, to comply with various regulatory authorities, an additional entity may be formed which enters into various relationships with SPE 106. For example, with reference now to FIG. 2, a similar system to that shown in FIG. 1 comprising bank 100, payment processor 104, SPE 106 and a check holder 108 are again provided. Again, payment processor/SPE 104, 106 provides check services to bank 100, bank 100 issues checks 102 and remits the amounts of checks 102 to payment processor/SPE 104, 106 on the business day following issuance of check 102. Payment processor/SPE 104, 106 pays check 102 when it is presented through a clearing bank. In the interim, between issuance of check 102 and payments on check 102, payment processor/SPE 104, 106 is permitted to invest the funds transferred from bank 100 to payment processor/SPE 104, 106 in certain permissible investments.

Additionally, in accordance with this embodiment of the present invention, a legal title entity 107 is provided. Legal title entity 107 suitably comprises an entity in accordance with the present invention with the ability to perform various actions and have certain ownership rights with respect to checks 102 and the assets backing those checks 102. For example, legal title entity 107 suitably has the ability to hold legal title to assets backing checks 102, without likewise having equitable ownership of the same. In such instances, various advantages of legal entity 107 may be realized.

For example, as mentioned above, while some states require SPE 106 to secure 100% of the value of checks 102 with various assets, including legal and equitable ownership of those assets, there are potential exceptions to the various state regulations which would require the same. Such exceptions include states which allow legal title entity 107 to act as a “designated nominee” for holding title to the relevant securities, while SPE 106 maintains all other ownership rights, including the right to invest funds relating to those assets. For example, in one non-limiting embodiment of the present invention, legal title entity 107 is in the form of a partnership (or other legal entity) which enters into a legal agreement with SPE 106 to act as the designated nominee of SPE 106. In such forms, the various regulatory authorities deem the financial institutions in compliance with the applicable regulations, while allowing SPE 106 to function as described above (e.g., investing funds) which otherwise would not be permitted, thus providing distinct advantages over the prior art.

That said, it should be appreciated that the term “designated nominee” is used for exemplary and illustrative purposes, but should not be construed as so limited. For example, many other designations which have a similar effect, i.e., provide legal title entity 107 with various rights on behalf of SPE 106, should likewise be construed as falling within the scope of the present invention.

In accordance now with various additional aspects of the present invention, SPE 106 may be provided with excess cash such as, for example, undistributed dividends. SPE 106 may also have a revolving credit loan program with a CAG. SPE 106 may hold liquid investments that may be sold. SPE 106 also may have the benefit of a letter of credit from another bank 112. Thus, the foregoing capabilities allow SPE 106 to be able to pay a greater amount of checks presented on a given day even when the remittances received that day are less than those checks presented.

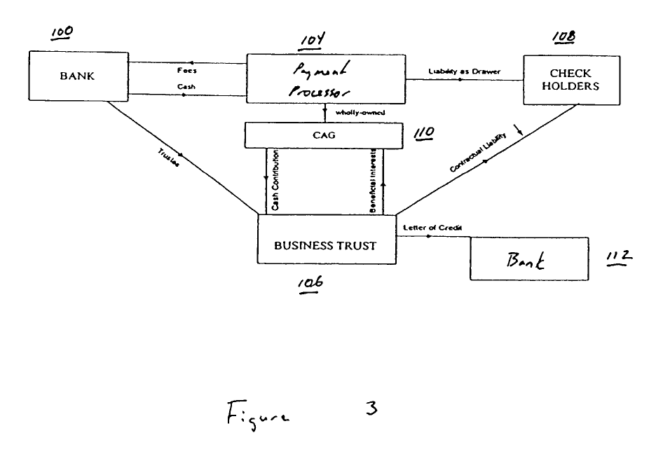

With reference now to FIG. 3, an alternative embodiment of the present invention is illustrated. As shown, payment processor 104 creates SPE 106 which is 100% owned by a CAG 110, preferably a wholly owned subsidiary of payment processor 104. CAG 104 preferably makes an initial capital contribution to SPE 106. SPE 106 then invests the total amount of cash provided to it in permissible investments held for the benefit of check holders 108. In accordance with the present invention, SPE 106 suitably assumes contractual liability for payments on checks 102. However, in accordance with various aspects of the present invention, if SPE 106 cannot or will not pay checks 102, payment processor 104 remains liable for such payment. Thus, SPE 106 formalizes statutory requirements that permissible investments are held in trust for check holders 108.

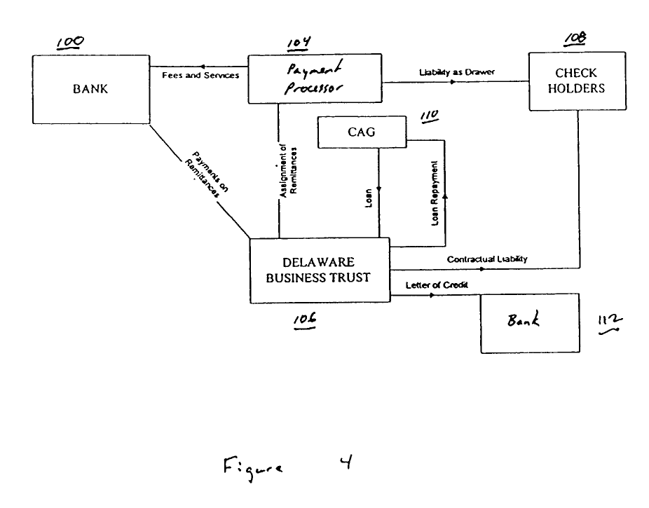

With reference now to FIG. 4, an alternative embodiment of the present invention is illustrated. In accordance with this embodiment, remittances due from bank 100 with respect checks 102 are suitably sold or contributed as capital to SPE 106 in return for assumption of liability to check holders 108. These remittances are suitably a net of amounts due from payment processor 104 to bank 100. Payments on the remittances are suitably made to SPE 106. CAG 110 lends money to SPE 106 under a revolving credit note. To the extent the amount of cash remittances obtained by SPE 106 daily is greater than amounts paid on checks 102, the note are paid down into the extent the amount of cash is less, the note will be increased. In accordance with this exemplary embodiment, payment processor 104 acts as an administrator for the transactions. Collections and investments are made in accordance with payment processor's 104 usual procedures with the exception that the investments are identified as belonging to SPE 106. Thus, SPE 106 tracks in substantially the same manner investments made by payment processor 104 with respect to different remittances. As described above, in the event SPE 106 has insufficient money to pay check holders 108, a draw may be made on items such as letters of credit provided by other banks or through payment processor 104 itself.

Last, while the principles of the invention have been made clear by the non-limiting, illustrative embodiments described above, there will be immediately obvious to those skilled in the art many modifications of structure, arrangements, proportions, the elements, materials and components, used in the practice of the invention which are particularly adapted for a specific environment and operating requirements without departing from those principles and/or the cope of the invention as set forth in the appended claims.

We claim:

1. A network of legal entities for carrying out financial transactions, comprising:
a financial institution which issues a payment obligation;
a special purpose entity, wherein said special purpose entity acquires (a) a residual obligation to honor said payment obligation, and (b) funds from said financial institution to honor said payment obligation;
a payment processor, wherein said payment processor acquires a residual obligation to honor said payment obligation if said special purpose entity does not honor said payment obligation; and
assets which secure said payment obligation.

2. The system of claim 1, wherein said special purpose entity invests said funds acquired from said financial institution prior to honoring said payment obligation.

3. The system of claim 1, wherein said financial institution comprises a bank.

4. The system of claim 1, wherein said special purpose entity comprises a trust.

5. The system of claim 1, wherein said special purpose entity is a bankruptcy remote entity.

6. The system of claim 1, wherein legal title to said assets is held by said special purpose entity.

7. The system of claim 1, further comprising a legal title entity acting as a designated nominee of said special purpose entity, and legal title to said assets is held by said legal title entity.

8. The system of claim 6, wherein said legal title entity is a partnership.

9. An improved system for carrying out financial transactions, comprising:
a bank which issues a payment obligation;
a special purpose entity, wherein said special purpose entity acquires (a) a residual obligation to honor said payment obligation, (b) acquires funds from said bank to honor said payment obligation, and (c) invests said funds prior to honoring said payment obligation;
a legal title entity acting as a designated nominee of said special purpose entity and holding legal title to assets which secure said payment obligation; and
a payment processor, wherein said payment processor acquires a residual obligation to honor said payment obligation if said special purpose entity does not honor said payment obligation.

10. The system of claim 9, wherein said special purpose entity comprises a trust.

11. The system of claim 9, wherein said legal title entity comprises a partnership.
